(19) United States
(12) Patent Application Publication
(10) Pub. No.: US 2017/0137711 A1
(43) Pub. Date: May 18, 2017

(54) BIODEGRADABLE SOIL CONDITIONER

(71) Applicant: Weinhold Scientific LLC, Strongsville, OH (US)

(72) Inventor: Robert Stepan, Strongsville, OH (US)

(73) Assignee: Weinhold Scientific LLC, Strongsville, OH (US)

(21) Appl. No.: 15/354,281

(22) Filed: Nov. 17, 2016

Related U.S. Application Data
(60) Provisional application No. 62/256,392, filed on Nov. 17, 2015.

(51) Int. Cl. C09K 17/18; C09K 17/14

(52) U.S. Cl. CPC C09K 17/18; C09K 17/14

(57) ABSTRACT

One or more techniques and/or systems are disclosed for a bio-derived, environmentally friendly soil conditioner to facilitate the removal of overburden (also known as spoil) in tunneling and mining operations. The bio-derived, biodegradable, and non-toxic formula may be injectable into the soil-cutter interface, and can thicken the tunnel water and disperse the soil to improve the removal of the spoil. The biodegradable soil conditioner may comprise: 1) about 45% to about 75% triglyceride oil by weight; 2) about 20% to about 50% super absorbent polymer by weight; and 3) about 1% to about 4% surfactant by weight. Further, the biodegradable soil conditioner may comprise about 0.1% to about 1.0% viscosity thickening agent.

This application claims priority to U.S. Ser. No. 62/256,392, entitled BIODEGRADABLE SOIL CONDITIONER, filed Nov. 17, 2015, which is incorporated herein by reference.

### BACKGROUND

Tunnel boring machines (TBM) may be used to cut a circular tunnel through the subterranean earth for various purposes such as underground highways, waterways, sewers, subways and thoroughfares. At the cutting head-earth interface, there may be large amounts of water and soil. The soil and water mix may be difficult to transport out of the cutting area.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

In one implementation, a biodegradable soil conditioner may comprise: 1) about 45% to about 75% triglyceride oil by weight; 2) about 20% to about 50% super absorbent polymer by weight; and 3) about 1% to about 4% surfactant by weight. Further, the biodegradable soil conditioner may comprise about 0.1% to about 1.0% viscosity thickening agent.

To the accomplishment of the foregoing and related ends, the following description sets forth certain illustrative aspects and implementations. These are indicative of but a few of the various ways in which one or more aspects may be employed. Other aspects, advantages and novel features of the disclosure will become apparent from the following detailed description.

### DETAILED DESCRIPTION

The claimed subject matter is now described, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

For tunneling and mining operations, TBM (tunnel boring machines) may cut a circular tunnel through the subterranean earth. In order to deter overhead earth from caving and decreasing the rate of earth removal, air pressure may be applied at the cutting head-earth interface. This elevated pressure may provide a positive force against the earth that may reduce clogging and increase the forward advancement of the tunneling machine. The viscosity of the water-soil slurry may create a seal to maintain the earth pressure balance (EPB). With EPB, there may be large amounts of water and soil at the cutting head-earth interface. In order to maintain pressure at the interface, the soil and water may be removed through a screw conveyor.

The soil and water mixture may be difficult to transport out of the subterranean cutting area. Previously, foaming agents and clay injections into the soil-water overburden have been used to improve the soil removal by thickening the slurry into a firm paste. Additionally, kerosene, diesel fuel, and thickeners may be added to the slurry to further facilitate smooth removal of the soil. However, the additions of these foaming agents, clay injections, thickeners, and other hazardous materials may be slow, costly, non-biodegradable, toxic, environmentally damaging, and ineffective. Using these materials, the slurry may not maintain a constant and homogenous viscosity, resulting in a drop of the positive pressure applied at the cutter-earth interface. This may result in a collapse of overburden, and may stall the EPB machine; workers who are certified divers (due to the elevated pressure) may have to go through a compression period before entering the cutter region to conduct repairs. Further, the delivery and blending of the soil, water and additives may require a period of time for the churning action of the disk shaped cutting tool to mix the constituents. A typical, sufficient time for properly mixing the components may be about 1 to about 2 hours. Even after thorough mixing, the result may not be homogeneous and the slurry may impede the cutting tool from moving forward.

In addition, the screw conveyor may not have a sufficient paste consistency for the water, soil, and either foaming agents or clay injections to maintain the pressure seal, which may impede the removal of the soil from the tunnel site. The pressure seal may wear and may require a replacement of the cutting inserts. Replacement of the cutting inserts can be time consuming and costly due to the need for professional divers to enter the high pressure soil-earth interface, along with a decrease in productivity of the TBM.

What is disclosed is a renewable, bio-derived, biodegradable, non-toxic soil conditioner that may be injectable into the soil-cutter interface. In one embodiment, the soil conditioner may be injected into various types of soil. In one embodiment, the soil conditioner may be a bio-derived environmentally friendly soil conditioner chemical formula. In another embodiment, the soil conditioner may facilitate removal of overburden (also referred to as spoil) in tunneling and mining operations. In another embodiment, the soil conditioner may facilitate earth removal.

In one embodiment, the soil conditioner may thicken the soil and water for removal. In one embodiment, the thickening of the soil and water may occur within about 30 minutes after injection of the soil conditioner. In another embodiment, the thickening of the soil and water may occur within about 15 minutes after injection of the soil conditioner. In another embodiment, the thickening of the soil and water may occur within about 5 minutes after injection of the soil conditioner. In another embodiment, the soil conditioner may have an interaction with the soil and water. In one embodiment, the soil conditioner may have an interaction with the soil and water to make a paste. In another embodiment, the paste may be composed of water, overburden, and the soil conditioner. In one embodiment, the soil conditioner may have an interaction with the soil and water to make a paste that may have a viscosity. In one implementation, the viscosity of the paste may be greater than about 20,000 centipoise (cP) at 20° C. In another implementation, the viscosity of the paste may be greater than about 30,000 cP at 20° C. In yet another implementation, the viscosity of the paste may be greater than about 40,000 cP at 20° C.

In another embodiment, the paste formed from the interaction of soil conditioner, soil, and water may be homogenous and have improved removal from the interface of the TBM and soil. For example, the paste may be of a viscosity and consistency to maintain the earth pressure balance. In one embodiment, the paste made from the soil conditioner, soil, and water may also have improved boundary lubrication properties, which may increase the life of the disk cutters of the TBM.

In one implementation, the soil conditioner may provide an efficient and environmentally safe formula that may efficiently thicken the water and soil into a paste that may be roughly homogenous. In one embodiment, the soil conditioner may provide a formula that may be injected into soil. In one embodiment, the soil conditioner may be injected by the Tunnel Boring Machine or Tunnel Boring Machine with Earth Pressure Balance (TBM-EPB). In another embodiment, the soil conditioner may be injected into the plenum areas of the TBM or TBM-EPB. In one embodiment, the rotating cutter head of the TBM or TBM-EPB may create a mixing action that may disperse the soil conditioner with cuttings. In one embodiment, the soil conditioner may provide an injectable formula that may be used under the earth pressure balance method. The earth pressure balance method is a mechanized tunneling method in which the excavated material is used to support the tunnel face using plasticizing materials in order to make it transportable. In another embodiment, the soil conditioner may provide an injectable formula that may reduce the amount of environmentally damage since the soil conditioner disclosed is both biodegradable and non-toxic to people, animals, plants, and the environment. In one embodiment, the soil conditioner may provide boundary lubrication at the cutter-earth interface for the disk cutters that may increase service life. Boundary lubrication is a type of lubrication that occurs between a liquid such as the soil conditioner described herein and a solid surface, for example disk cutters, in close contact. In one embodiment, the soil conditioner may provide boundary lubrication and a constant pressure at the cutter-earth interface for the disk cutters that may reduce repairs to the disk cutters.

In one implementation, a biodegradable soil conditioner may comprise a certain composition. In one implementation, a biodegradable soil conditioner may comprise: 1) about 45% to about 75% triglyceride oil by weight; 2) about 20% to about 50% super absorbent polymer by weight; and 3) about 1% to about 4% surfactant by weight. Further, the biodegradable soil conditioner may comprise about 0.1% to about 1.0% viscosity thickening agent. Formula examples are provided herein.

In one embodiment, a non-toxic, renewable, bio-derived, and biodegradable soil conditioner for the use in the process of TBM and EPB tunneling may comprise at least one triglyceride oil and/or its methyl ester derivatives. In one implementation, at least one triglyceride oil and/or its methyl ester derivatives may be renewable. In one implementation, at least one triglyceride oil and/or methyl ester derivatives may be bio-derived. In another implementation, at least one triglyceride oil and/or its methyl ester derivatives may be biodegradable. In yet another implementation, at least one triglyceride oil and/or its methyl ester derivatives may be non-toxic to humans, animals, plants, and the environment. In one embodiment, the triglyceride oil and/or its methyl ester derivatives may be corn oil. In another embodiment, the triglyceride oil and/or its methyl ester derivatives may be soybean oil. In one embodiment, the triglyceride oil and/or its methyl ester derivatives may be canola oil. In yet another embodiment, the triglyceride oil and/or its methyl ester derivatives may comprise at least one of corn oil, soybean oil, and canola oil. In another embodiment, the triglyceride oil and/or its methyl ester derivatives may comprise corn oil, soybean oil, and canola oil. In one embodiment, the triglyceride oil and/or its methyl ester derivatives may also comprise at least one of corn oil, sunflower oil, safflower oil, soybean oil, canola oil, palm oil, palm kernel oil, rice bran oil, coconut oil, olive oil, peanut and other nut oils, linseed oil, and cottonseed oil. In one embodiment, the triglyceride oil and/or methyl ester derivatives may be a byproduct of an ethanol fermentation process. In another embodiment, corn oil may be a by-product of the ethanol fermentation process, for example, renewable, biodegradable and non-toxic Poet Voila corn oil. Poet Voila corn oil does not qualify as a food product, so its use may not deplete food resources. In one embodiment, the soil conditioner may comprise about 45% to about 75% by weight triglyceride oil and/or its methyl ester derivatives. In another embodiment, the soil conditioner may comprise about 50% to about 70% by weight triglyceride oil and/or its methyl ester derivatives. In one embodiment, the amount of triglyceride oil and/or its methyl ester derivatives may be adjusted to control the final viscosity of the soil conditioner.

In another embodiment, the soil conditioner may comprise a rapid water absorbing agent, or super absorbent polymer. A rapid water absorbing agent or super absorbent polymer is material which may have a capacity to hold or absorb relatively large amounts of liquid relative to its own mass, even under pressures. In one embodiment, the super absorbent polymer may absorb and maintain liquids. In another embodiment, the liquid may be water. In one embodiment, the efficacy of the super absorbent polymer ranges may be about 300 to about 500 times its weight in water.

In one embodiment, the super absorbent polymer may include at least one of, but may not be limited to, acrylic acid sodium salt, sodium polyacrylate, polyacrylamide copolymer, ethylene maleic anhydride copolymer, cross-linked carboxymethylcellulose, polyvinyl alcohol copolymers, cross-linked polyethylene oxide, and starch grafted copolymer of polyacrylonitrile. In one embodiment, the super absorbent polymer may include at least two of, but may not be limited to, acrylic acid sodium salt, sodium polyacrylate, polyacrylamide copolymer, ethylene maleic anhydride copolymer, cross-linked carboxymethylcellulose, polyvinyl alcohol copolymers, cross-linked polyethylene oxide, and starch grafted copolymer of polyacrylonitrile. In one embodiment, the soil conditioner may comprise about 20% to about 50% by weight super absorbent polymer. In another embodiment, the soil conditioner may comprise about 30% to about 50% by weight super absorbent polymer.

In one embodiment, the soil conditioner may comprise at least one surfactant to provide the soil dispersion into the paste. In one embodiment, the surfactant(s) may provide wetting of the soil and may prevent re-agglomeration and coalescence of the soil in the soil conditioner. In one embodiment, the surfactant(s) used in the soil conditioner may include one or more from the Environmental Protection Agency's (EPA) designed for the environment (DFE) program, which recognizes surfactants that may be safer for human health and the environment. DFE surfactants may break down quickly to non-polluting compounds and be safer for aquatic life in both fresh and salt water. In one embodiment, at least one surfactant may provide a hydrophilic-lipophilic balance (HLB) value of about 8.0 to about 11.2. In another embodiment, at least one surfactant may provide an HLB value of about 9.5 to about 10.5. In one embodiment, at least one surfactant may include, but may not be limited to, sorbitan esters, sorbitan ester ethoxylates, natural alcohol ethoxylates (for example, Dow Ecosurf™ EH-6, EH-9), seed oil surfactant (for example, Dow Ecosurf™ SA-9), sodium lauroyl sarcosinate, tall oil fatty acid soaps, oleic acid soaps, castor ethoxylates (for example, Chemax CO-5 and CO-16) and cocobetaines, alkyl polyglucosides (for example, Dow Triton™ BG-10 and Triton™ CG-110), sodium dodecyl benzene sulfonate, and linear alcohol ethoxylates (for example, Dow Tergitol™ 15-s30). In one embodiment, at least one surfactant may be about 1.0% to about 4.0% by weight of the total formula of the soil conditioner. In another embodiment, the total surfactant composition may be about 2.0% to about 3.0% by weight of the total formula of the soil conditioner.

In another embodiment, the soil conditioner may comprise a viscosity thickening agent (also called a rheology modifier) that may suspend the super absorbent polymer in the triglyceride oil. In another implementation, the triglyceride oil may also contain its methyl ester derivatives. In one embodiment, the viscosity thickening agent may allow at least a partially homogenous distribution of super absorbent polymer within the soil conditioner product. In one embodiment, the viscosity thickening agent may be considered non-toxic to people, animals, plants, and the environment, and may mitigate potential harm to the environment. In one embodiment, the viscosity thickening agent may include, but may not be limited to, fumed silica (Cabosil™ M-5), natural gums, xanthan gum, guar gum, hydroxyethyl cellulose ether, carboxy methyl cellulose (CP Kelco™), hydroxyl propyl cellulose ether (Klucel H™), hydroxypropyle methyl cellulose (HPMC Aldrich), clay (Veegum™ RT Vandebilt), starch, carrageenan, myristyl myristate, and colloidal oatmeal. In another embodiment, fumed silica, xanthan gum, or clay may also be used in the soil conditioner to either increase viscosity or provide a more uniform viscosity. In one embodiment, about 0.10% to about 1.0% by weight of at least one viscosity thickening agent may be used. In another embodiment, about 0.10% to about 0.5% by weight of at least one viscosity thickening agent in the soil conditioner may provide a viscosity of about 1500 centipoise (cP) to about 4000 centipoise (cP) at 20° C.

In one embodiment, the soil conditioner may be prepared through the use of a mixer to combine the components of the soil conditioner. In another embodiment, the soil conditioner may be prepared through the use of a high shear mixer. In another embodiment, the soil conditioner may be prepared by a high shear mixer to at least partially homogenize the components. In another embodiment, the components of the soil conditioner may be added into a mixing tank in order to prepare the soil conditioner. In yet another embodiment, the components of the soil conditioner may be added into a mixing tank starting with the triglyceride oil. In one embodiment, a high shear mixer may be used with a blade configuration that may efficiently disperse and blend the soil conditioner. In another embodiment, a homogenizer, colloid mill, or Ross™ mill may be used to disperse all components into at least a partially homogenous product.

In one embodiment, the soil conditioner may provide lubricating properties for the TBM. Since the cutter-earth interface may produce high levels of friction, and may limit the progress of the TBM's forward progress, the soil conditioner may aid in lubrication between the soil and TBM. In another embodiment, the use of the soil conditioner may at least partially reduce friction for the TBM. In yet another embodiment, the use of the soil conditioner may at least partially reduce repairs such as frequent replacement of the cutters, which may create costly downtime. In one embodiment, the use of the soil conditioner may provide increased cutter life, increased forward advancements, less downtime, and lower energy requirements to the tunneling operation.

The soil conditioner can respond and preform in a wide variety of soil conditions. Some formula examples may include:

Sample A:

| | | |
|---|---|---|
| Poet Voila ™ corn oil | 50.0% | w/w |
| Super absorbent polymer | 47.0% | w/w |
| Clay Veegum ™ | 1.0% | w/w |
| Tween 80 (ICI) | 1.2% | w/w |
| Span 80 (ICI) | 0.8% | w/w |
| Viscosity @ 20° C. | 3200 | cP |
| Thickening time* | 1.4 | minutes |
| Thickened viscosity* | >40,000 | cP |

*thickening evaluation conducted using Seattle Tunnel project overburden earth blended 1:1 with tap water (120 ppm total hardness), then measured for Thickened Viscosity

Sample B:

| | | | |
|---|---|---|---|
| Soybean Oil (Cargil) | 50.0% | w/w | |
| Super absorbent polymer | 47.0% | w/w | |
| Clay Veegum | 1.0% | w/w | |
| (R T Vanerbilt) | | | |
| Tween 80 (ICI) | 1.2% | w/w | |
| Span 80 (ICI) | 0.8% | w/w | |
| Viscosity @ 20° C. | 2650 | cPThickening time* | 1.8 minutes |
| Thickened viscosity* | >40,000 | cP | |

*thickening evaluation conducted using Seattle Tunnel project overburden earth blended 1:1 with tap water (120 ppm total hardness), then measured for Thickened Viscosity

Sample C:

| | | |
|---|---|---|
| Soybean Oil (Cargil) | 50.0% | w/w |
| Super absorbent polymer | 47.0% | w/w |
| Fumed Silica (Cabot M-5) | 1.0% | w/w |
| Tween 80 (ICI) | 1.2% | w/w |
| Span 80 (ICI) | 0.8% | w/w |
| Viscosity @ 20° C. | 1890 | cP |
| Thickening time* | 2.2 | minutes |
| Thickened viscosity* | >40,000 | cP |

*thickening evaluation conducted using Seattle Tunnel project overburden earth blended 1:1 with tap water (120 ppm total hardness), then measured for Thickened Viscosity

Sample D:

| | | |
|---|---|---|
| Poet Voila ™ corn oil | 67.0% | w/w |
| Super absorbent polymer | 30.0% | w/w |
| Clay Veegum ™ | 1.0% | w/w |
| Tween 80 (Sigma Aldrich) | 1.2% | w/w |
| Span 80 (Sigma Aldrich) | 0.8% | w/w |
| Viscosity @ 20° C. | 1800 | cP |
| Thickening time* | 3.5 | minutes |
| Thickened viscosity* | >20,000 | cP |

*thickening evaluation conducted using overburden earth blended 1:1 with tap water (120 ppm total hardness) 4.0% w/w Sample D, then measured for Thickened Viscosity

Sample E:

| | | |
|---|---|---|
| Soybean Oil (Cargill) | 67.0.0% | w/w |
| Super absorbent polymer | 30.0% | w/w |
| Clay Veegum (R T Vanderbilt) | 1.0% | w/w |
| Tween 80 (Sigma Aldrich) | 1.2% | w/w |
| Span 80 (Sigma Aldrich) | 0.8% | w/w |
| Viscosity @ 20° C. | 1540 | cP |
| Thickening time* | 1.9 | minutes |
| Thickened viscosity* | >30,000 | cP |

*thickening evaluation conducted using Seattle Tunnel project overburden earth blended 1:1 with tap water (120 ppm total hardness)/4.0% w/w Sample E, then measured for Thickened Viscosity

A lubrication evaluation using the Falex Four Ball Extreme Pressure Machine using ASTM D-2783 method:

Sample A:

| | |
|---|---|
| Last non-seizure load | 150 kg |

Sample B:

| | |
|---|---|
| Last non-seizure load | 150 kg |

The soil conditioner described herein may be used in various soil types. In one example, a soil sample of about 45% rock, 5% soil, and 50% water may have a viscosity of about 25000 cP within about 30 seconds. In another example, a soil sample of about 5% rock, 45% soil, and 50% water may have a viscosity of about 32000 cP within about 45 seconds. In yet another example, a soil sample of about 30% rock and 70% water may have a viscosity of about 40000 cP within about 80 seconds. In another example, a soil sample of about 30% soil and 70% water may have a viscosity of about 44000 cP within about 120 seconds.

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

What is claimed is:

1. A soil conditioner comprising:
about 45% to about 75% triglyceride oil by weight;
about 20% to about 50% super absorbent polymer by weight; and
about 1% to about 4% surfactant by weight.

2. The soil conditioner of claim 1, wherein the triglyceride oil is comprised of at least one of corn oil, soybean oil, and canola oil.

3. The soil conditioner of claim 1, wherein the triglyceride oil is a byproduct of an ethanol fermentation process.

4. The soil conditioner of claim 1, wherein the triglyceride oil is comprised of at least one of corn oil, sunflower oil, safflower oil, soybean oil, canola oil, palm oil, palm kernel oil, rice bran oil, coconut oil, olive oil, peanut and other nut oils, linseed oil, and cottonseed oil.

5. The soil conditioner of claim 1, wherein the super absorbent polymer is comprised of at least one of acrylic acid sodium salt, sodium polyacrylate, polyacrylamide copolymer, ethylene maleic anhydride copolymer, cross-linked carboxymethylcellulose, polyvinyl alcohol copolymers, cross-linked polyethylene oxide, and starch grafted copolymer of polyacrylonitrile.

6. The soil conditioner of claim 1, wherein the surfactant has an HLB value of about 8.0 to about 11.2.

7. The soil conditioner of claim 1, wherein the surfactant has an HLB value of about 9.5 to about 10.5.

8. The soil conditioner of claim 1, wherein the surfactant is comprised of at least one of sorbitan esters, sorbitan ester ethoxylates, natural alcohol ethoxylates, seed oil surfactant, sodium lauroyl sarcosinate, tall oil fatty acid soaps, oleic acid soaps, castor ethoxylates and cocobetaines, alkyl polyglucosides, sodium dodecyl benzene sulfonate, and linear alcohol ethoxylates.

9. The soil conditioner of claim 1, further comprising:
about 0.1% to about 1.0% viscosity thickening agent.

10. The soil conditioner of claim 9, wherein the viscosity thickening agent is at least one of fumed silica, natural gums, xanthan gum, guar gum, hydroxyethyl cellulose ether, carboxy methyl cellulose, hydroxyl propyl cellulose ether, hydroxypropyle methyl cellulose, clay, starch, carrageenan, myristyl myristate, and colloidal oatmeal.
